(19) United States
(12) Patent Application Publication
(10) Pub. No.: US 2016/0301616 A1
(43) Pub. Date: Oct. 13, 2016

(54) BANDWIDTH CONTROL METHOD, PACKET RELAY DEVICE, AND STORAGE MEDIUM

(71) Applicant: FUJITSU LIMITED, Kawasaki-shi (JP)

(72) Inventor: Atsushi Kitada, Kawasaki (JP)

(73) Assignee: FUJITSU LIMITED, Kawasaki-shi (JP)

(21) Appl. No.: 15/071,851

(22) Filed: Mar. 16, 2016

(30) Foreign Application Priority Data
Apr. 9, 2015 (JP) 2015-080381

(51) Int. Cl. H04L 12/823; H04L 12/819

(52) U.S. Cl. CPC H04L 47/32; H04L 47/215

(57) ABSTRACT

A bandwidth control method includes measuring a passing amount of a packet, represented by a plurality of digits; notifying another interface device of a value of a high-order-side digit; adding a value of a low-order-side digit to a passing amount of a packet to be measured in a following period according to a predetermined interval; calculating a provisional passing amount by adding the value of the high-order-side digit notified by the another interface device to the measured passing amount; determining whether to allow a target packet to pass when the target packet is received, based on a result of subtracting the provisional passing amount from an allowable passing amount that increases at a predetermined rate and decreases when a packet passes; allowing the target packet to pass when the target packet is allowed to pass; and discarding the target packet when the target packet is not allowed to pass.

### CROSS-REFERENCE TO RELATED APPLICATION

This application is based upon and claims the benefit of priority of the prior Japanese Patent Application No. 2015-080381, filed on Apr. 9, 2015, the entire contents of which are incorporated herein by reference.

### FIELD

The embodiments discussed herein are related to a bandwidth control method, a packet relay device, and a storage medium.

### BACKGROUND

A packet relay device configured to relay a packet includes a plurality of policers each having a policing function, respectively for interface cards (hereinafter referred to as an “IF card”) configured to process transmission and reception of a packet. A policer allows a packet to pass by consuming tokens supplied at a fixed policing rate. Then, when tokens run short, the policer controls bandwidth of packets passing through a packet relay device by discarding packets (See Japanese Laid-open Patent Publication No. 2013-197823, for example).

A policer controls bandwidth for every traffic of a user identified by a virtual local area network (VLAN) identifier (VID) or a multi-protocol label switching (MPLUA) label of a packet. Thus, a token supply rate of each policer, that is to say, a policing rate, is determined depending on bandwidth for which a user makes a contract, or the like.

For example, in order to improve a superficial communication speed, link aggregation that bundles a plurality of links (physical communication lines) is used. In this case, if a packet of traffic of the same user is inputted to a plurality of policers provided for different IF cards, the plurality of policers are grouped. Then, every time any policer belonging to the group allows a packet to pass, tokens of all the policers are consumed.

This enables overall limitation of total bandwidth of traffic of the same user which is inputted over a plurality of policers. This bandwidth control method (hereinafter referred to as “group policing”) may be performed on a group of a plurality of policers to which each of packets of traffic of different users is inputted.

In the group policing, each policer belonging to the same group measures a data amount of a packet that has passed through the policer, that is to say, a passing amount, for a certain period of time, and notifies the passing amount to policers of other IF cards. Each policer subtracts from token of that policer the passing amount notified from the policers of other IF cards.

When the policing rate and the number of policers increase, an amount of information transmitted and received between policers of different IF cards increases. Thus, each IF card desirably has large-scale hardware with a transfer capacity commensurate with the amount of information.

For example, when the policing rate is 100 (Gb/s) and a cycle of notification of the passing amount is 10 (ms), a data amount of packets passing in 10 (ms) is 125 (MBytes) (=100/8×0.01) at a maximum. Thus, the amount of information desirable for notification of the passing amount is 27 (bits) when converted into a binary number.

When the number of policers mounted on one IF card is 100,000 units, a transmission rate desirable for the IF card is 270 (Mb/s) (=27×100K/0.01). If the group policing is carried out among four IF cards, a reception rate desirable for each IF card is 1.08 (Gb/s) (=270×4). Thus, it is desirable for each IF card to have the data transfer capacity of a gigabit rate, aside from a packet of a main signal. If an IF card notifies each policer of a passing amount with an individual packet, the amount of information to be transmitted and received increases, which thus requests higher transfer capacity.

For example, if the cycle of notification of the passing amount is shortened to 1 (ms), the data amount of packets passing in 1 (ms) is 12.5 (MBytes) (=100/8×0.001) at a maximum. Therefore, the amount of information desirable for notification of the passing amount is 21 (bits) (<27 (bits)) when converted to a binary number.

On the other hand, if the cycle of notification of the passing amount is extended to 100 (ms), for example, the data amount of packets passing in 100 (ms) is 1.25 (GBytes) (=100/8×0.1) at a maximum. Therefore, the amount of information desirable for notification of the passing amount is 31 (bits) (>27 (bits)) when converted to a binary number.

In this manner, if time interval to notify a passing amount is shortened, frequency of notification increases although the amount of information transmitted and received in one notice decreases. On the other hand, if the time interval to notify a passing amount is extended, the amount of information transmitted and received in one notice increases although the frequency of notification decreases. Therefore, an IF card is requested to have a high transfer capacity irrespective of time interval to notify a passing amount. It is desirable that bandwidth control with which the amount of information to be notified is reduced is possible.

### SUMMARY

According to an aspect of the invention, a bandwidth control method executed by one of a plurality of interface devices included in a packet relay device and that process transmission or reception of a packet, the bandwidth control method includes measuring a passing amount of a packet, the passing amount being represented by a numeric value of a plurality of digits; notifying another interface device among the plurality of interface devices of a numeric value of a high-order-side digit of the plurality of digits; adding a numeric value of a low-order-side digit of the plurality of digits of the passing amount to a passing amount of a packet to be measured in a following period according to a predetermined measurement interval; calculating a provisional passing amount by adding the numeric value of the high-order-side digit notified by the another interface device to the measured passing amount; determining whether to allow a target packet to pass when the target packet is received, based on a result of subtracting the provisional passing amount from an allowable passing amount that increases at a predetermined rate and decreases when a packet passes; allowing the target packet to pass when determining that the target packet is allowed to pass; and discarding the target packet when determining that the target packet is not allowed to pass.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a packet relay device;

FIG. 2 is a configuration diagram illustrating an example of an interface card;

FIG. 3 is a diagram illustrating a route of a packet in the packet relay device;

FIG. 4 is a configuration diagram illustrating an example of a bandwidth controller;

FIG. 5 is a diagram illustrating a token management table;

FIG. 6 is a flowchart illustrating an example of processing of a token management unit;

FIG. 7 is a flowchart illustrating an example of a policing unit;

FIG. 8 is a diagram illustrating an example of interface cards that constitute a policing group;

FIG. 9 is a diagram illustrating an example of a notification process of a passing amount;

FIG. 10 is a flowchart illustrating an example of processing of a passing amount notifier;

FIG. 11 is a flowchart illustrating an example of processing of a passing amount receiver;

FIG. 12 is a diagram illustrating an example of processing of a passing amount management table and a provisional passing amount management table;

FIG. 13 is a graph illustrating an example of a change in a passing amount and a provisional passing amount in each term;

FIG. 14 is a diagram illustrating other example of processing of the passing amount management table and the provisional passing amount management table;

FIG. 15 is a diagram illustrating other example of a notification process of a passing amount;

FIG. 16 is a diagram illustrating an example of bandwidth control;

FIG. 17A is a graph illustrating a simulation result of an output rate in a comparative example; and

FIG. 17B is a graph illustrating a simulation result of an output rate in an example.

### DESCRIPTION OF EMBODIMENTS

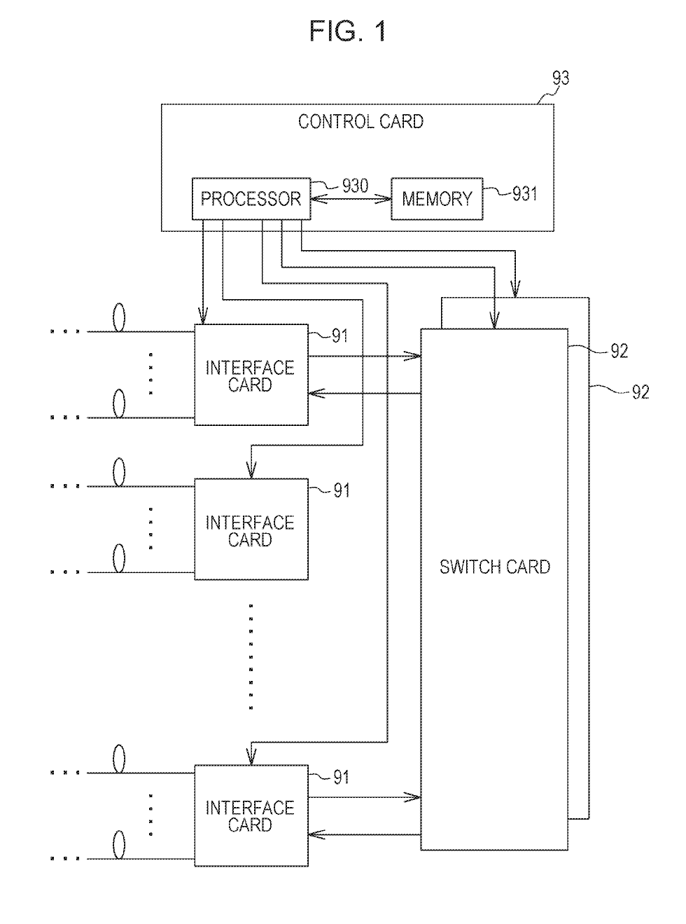

FIG. 1 is a configuration diagram illustrating an example of a packet relay device. A packet relay device includes a plurality of interface cards (IF cards) 91, two switch cards 92, and a control card 93. The cards 91 to 93 are housed respectively in individual slots provided in a housing and electrically connected with each other. The packet relay device may be a layer 2 switch or a router, for example.

The packet relay device relays a packet received from another device to another device according to a destination of the packet. In this example, a packet is a transmission unit (PDU: Protocol Data Unit) of data (information) to be transmitted. The packet is an Ethernet (registered trademark) (the same applies hereinafter) frame, for example. The packet is not limited to this, and another PDU such as an internet protocol (IP) packet may also be used.

Each of the plurality of IF cards 91 transmits and receives a packet to and from another device. The other device is a terminal device such as a personal computer, a server device, or a router, for example. The plurality of IF cards 91 are connected with optical fibers and perform communications based on the 10GBASE-LR standard, for example.

Each of the two switch cards 92 exchanges a packet among the plurality of IF cards 91. More specifically, the switch card 92 receives a packet from the IF card 91 and outputs the packet to the IF card 91 corresponding to a destination of the packet. In case of a fault such as a hardware failure, the two switch cards 92 are used as a current system and a spare system.

The control card 93 controls the plurality of IF cards 91 and the two switch cards 92. The control card 93 is connected with a network control device or the like. The control card 93 performs a process related to a user interface, a setting process on each card 91, 92, and an information collection process from each card 91, 92. The control card 93 has a processor 930 such as a central processing unit (CPU) configured to perform these processes, and a memory 931 configured to store a program that drives the processor 930.

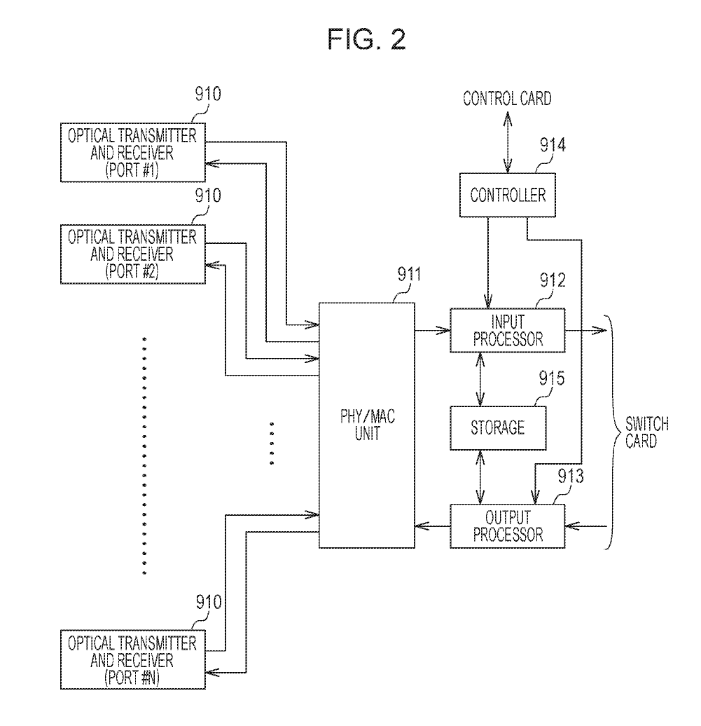

FIG. 2 is a configuration diagram illustrating a functional configuration of the IF card 91. The IF card 91 includes a plurality of optical transmitters and receivers 910, a PHY/MAC unit 911, an input processor 912, an output processor 913, a controller 914, and a storage 915.

Each of the plurality of optical transmitters and receivers 910 converts to an electric signal an optical signal received from another device through an optical fiber and outputs the signal to the PHY/MAC unit 911. Each of the plurality of optical transmitters and receivers 910 converts to an optical signal the electric signal inputted from the PHY/MAC unit 911 and transmits the signal to another device through the optical fiber. In other words, the plurality of optical transmitters and receivers 910 function as a plurality of ports #1 to #N (N: a positive integer) to transmit and receive a packet between other devices.

The PHY/MAC unit 911 performs a process to establish a link with another device or a process to distribute packets to the plurality of optical transmitters and receivers 910. The PHY/MAC unit 911 outputs to the input processor 912 packets inputted from the plurality of optical transmitters and receivers 910. The PHY/MAC unit 911 outputs to the plurality of optical transmitters and receivers 910 packets inputted from the output processor 913.

The input processor 912 and the output processor 913 are logical circuits such as a field programmable gate array (FPGA) or an application specific integrated circuit (ASIC) and each perform packet processing of INGRESS and EGRESS. The input processor 912 performs a bandwidth control process of a packet inputted from the PHY/MAC unit 911 and outputs the packet to the switch card 92.

The output processor 913 performs a control process of a transmission rate, or the like, of a packet inputted from the switch card 92 and outputs the packet to the PHY/MAC unit 911. The storage 915 is a storage unit such as a memory and stores various types of data that the input processor 912 and the output processor 913 use for processing.

The controller 914 communicates with the control card 93 to control the input processor 912 and the output processor 913. The controller 914 includes a processor such as a CPU and a memory (not illustrated). Processing of the controller 914 is, for example, various setting processes of the input processor 912 and the output processor 913, and a process to collect an alarm detected by the input processor 912 and the output processor 913.

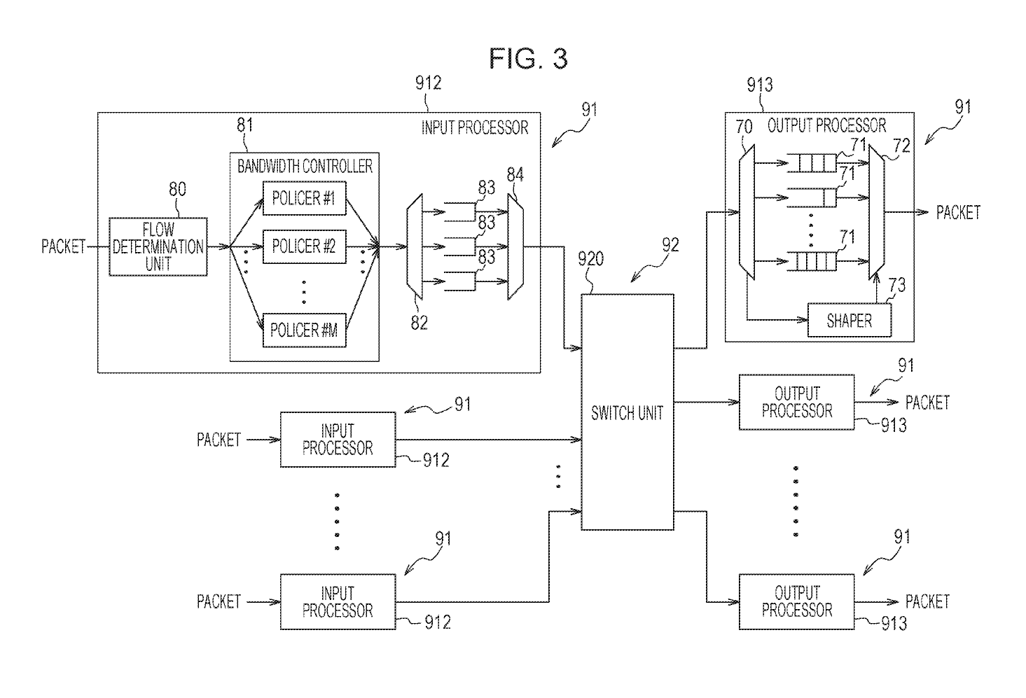

FIG. 3 illustrates a route of a packet in the packet relay device. FIG. 3 also illustrates a configuration of the input processor 912 and the output processor 913.

First, a packet is inputted to the input processor 912 of the IF card 91. The input processor 912 includes a flow determination unit 80, a bandwidth controller 81, a distribution unit 82, a plurality of input queues 83, and an output unit 84.

The flow determination unit 80 determines traffic of a packet, more specifically, flow, based on a VID or MPLS label assigned to the inputted packet. After determination, the flow determination unit 80 assigns a policer ID (PID) corresponding to packet flow, for example, to a packet. A PID is stored in an intra-device header assigned to a packet in the packet relay device, for example.

The bandwidth controller 81 has a plurality of policers #1 to #M (M: a positive integer) corresponding to PIDs. The bandwidth controller 81 sorts packets to the plurality of policers #1 to #M based on PIDs assigned to packets, for example. Thus, even when packets of the same user are inputted from different ports 910, for example, the packets of that user are inputted to common policers #1 to #M. The plurality of policers #1 to #M discard any packet exceeding predetermined bandwidth, so that a traffic amount of packets inputted does not exceed the predetermined bandwidth.

The policers #1 to #M allow a packet to pass by consuming tokens supplied at a fixed policing rate. When tokens run short, the policers #1 to #M control bandwidth of packets passing through the bandwidth controller 81 by discarding packets. A token is an example of an allowable passing amount for allowing packets to pass. Since the policers #1 to #M control bandwidth of each user traffic, a token supply rate of each of the policers #1 to #M, more specifically, a policing rate, is determined depending on bandwidth for which a user makes a contract. A packet that passes through the policers #1 to #M is inputted to the distribution unit 82.

The distribution unit 82 distributes packets to the plurality of input queues 83, according to the IF cards 91 which are destinations. More specifically, the input queue 83 is provided in each IF card 91. The plurality of input queues 83 accumulate packets until the packets are read out by the output unit 84. The output unit 84 selects one of the plurality of input queues 83, reads out a packet from the selected input queue 83, and outputs the packet to a switch unit 920 of the switch card 92. The switch unit 920 outputs the inputted packet to the output processor 913 of the IF card 91 corresponding to a destination of the inputted packet.

The output processor 913 includes a distribution unit 70, a plurality of queues 71, a read-out processing unit 72, and a shaper (scheduler) 73. A packet outputted from the switch unit 920 is inputted to the distribution unit 70. The distribution unit 70 distributes packets to the plurality of queues 71 for each traffic of the above-mentioned user, for example.

The read-out processing unit 72 reads out packets from the plurality of queues 71 according to an instruction from the shaper 73. The read packet is transmitted from a port 910 to another device.

The shaper 73 acquires information (such as a data amount of a packet or the like) on a packet stored in each of the plurality of queues 71 from the distribution unit 70. Then, the shaper 73 instructs the read-out processing unit 72 on a queue to be read out from the plurality of queues 71. With this, a transmission rate of each traffic is controlled appropriately.

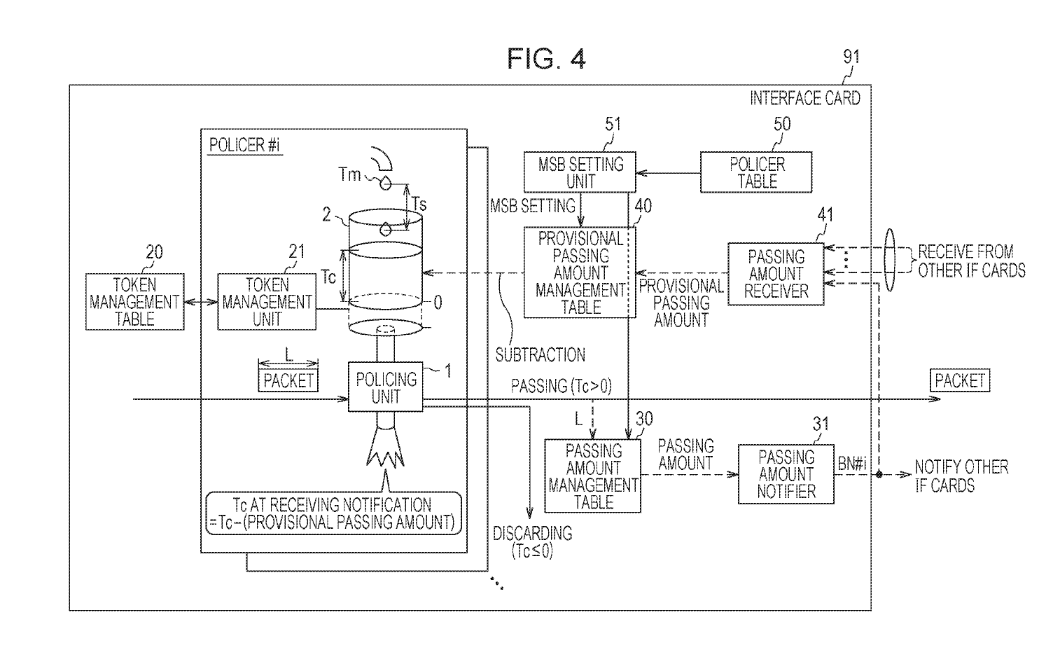

FIG. 4 is a configuration diagram illustrating an example of the bandwidth controller 81. The bandwidth controller 81 includes the above-mentioned a plurality of policers #1 to #M, a token management table 20, a passing amount management table 30, a passing amount notifier 31, a provisional passing amount management table 40, a passing amount receiver 41, a policer table 50, and an MSB setting unit 51. The bandwidth controller 81 controls bandwidth of a packet passing through the policer #1 to #M.

Each of the plurality of policers #1 to #M has a policing unit 1 and a token management unit 21 that functions as a token packet 2. While only a configuration of the policer #i (i: a positive integer) of the plurality of policers #1 to #M is illustrated in FIG. 4, other policers have a configuration similar to the policer #i.

The policer #i belongs to the same group as a policer #i of another IF card 91 and performs group policing. More specifically, policers having the same PID in the plurality of IF cards 91 belong to the same group. Thus, in each IF card 91, the policing unit 1 and the token management unit 21 are provided in each group. No limitation is set to the number of policers to be grouped.

The token packet 2 accumulates tokens supplied at a fixed policing rate. A policing rate (=amount of supplied tokens Tm at one time/time interval Ts during which tokens are supplied) is determined for traffic inputted depending on bandwidth for which a user makes a contract. The token packet 2 is a conceptual configuration illustrated as a unit to manage a token accumulation amount Tc.

A policing rate is set for the same value among policers #i belonging to the same group. More specifically, a policing rate of policers belonging to the same group is common among respective IF cards 91. If any policer #i belonging to the same group allows a packet to pass, tokens of all policers #i are reduced.

With this, total bandwidth of traffic of the same user inputted across policers #i of a plurality of different IF cards 91 or total bandwidth of traffic of different users is generally controlled.

The token management unit 21 manages a token accumulation amount Tc or the like with a token management table 20 stored in the storage 915.

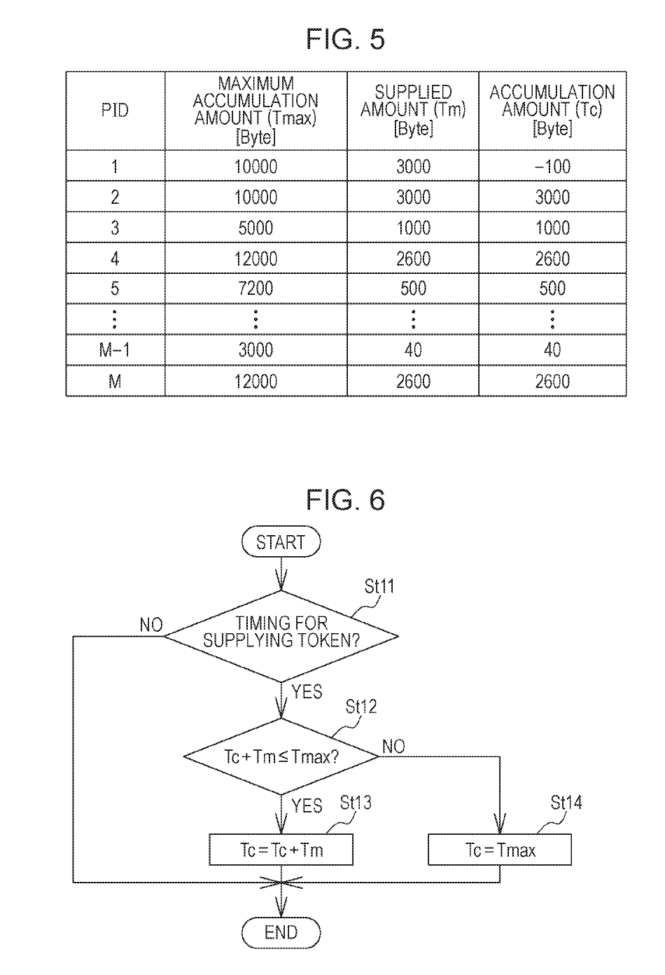

FIG. 5 illustrates an example of the token management table 20. In the token management table 20, a “maximum accumulation amount (Tmax) [Byte]”, “supplied amount (Tm) [Byte]”, and “accumulation amount (Tc) [Byte]” are registered for each PID. The token management table 20 is shared among respective policers #1 to #M.

The “accumulation amount (Tc) [Byte]” represents a token accumulation amount Tc in the token packet 2 in the unit of Byte. The “maximum accumulation amount (Tmax) [Byte]” represents the largest amount of tokens that may be accumulated in the token packet 2 in the unit of Byte. The accumulation amount Tc is limited so that the accumulation amount Tc does not exceed the maximum accumulation amount. The “supplied amount (Tm) [Byte]” represents a token amount Tm cyclically supplied at the time interval Ts in the unit of Byte.

In the same group, the maximum accumulation amount Tmax and the supplied amount Tm of tokens are common in respective policers because the policing rate is common. For example, respective policers #1 of the IF cards 91 belonging to the same group both have the maximum accumulation amount Tmax of 10000 (Bytes) and the supplied amount Tm of 3000 (Bytes) of tokens. The maximum accumulation amount Tmax and the supplied amount Tm of tokens are each set in advance by the control card 93, for example. The time interval Ts during which token are supplied is determined depending on a policing rate registered in the policer table 50, and common among policers in the same group.

The token management unit 21 acquires the accumulation amount Tc and the supplied amount Tm from the token management table 20 when timing for supplying tokens comes. Then, the token management unit 21 updates the accumulation amount Tc in the token management table 20 by adding the supplied amount Tm to the accumulation amount Tc.

FIG. 6 is a flowchart illustrating an example of processing of the token management unit 21. The processing is repeatedly performed at a fixed cycle.

First, the token management unit 21 determines whether or not timing for supplying a token comes (St11). For example, the token management unit 21 detects timing for supplying a token with a built-in timer. The timing for supplying a token comes in every time interval Ts, and is determined by the policing rate of each of the policers #1 to #M registered in the policer table 50. The time interval Ts is calculated by dividing the supplied amount Tm by the policing rate. The token management unit 21 terminates the processing if the timing for supplying a token does not come (No in St11).

When the timing for supplying a token comes (Yes in St11), the token management unit 21 determines whether or not a sum of the accumulation amount Tc and the supplied amount Tm is equal to or smaller than the maximum accumulation amount Tmax (St12). When Tc+Tm≦Tmax (Yes in St12), the token management unit 21 adds the supplied amount Tm to the accumulation amount Tc (St13) and then terminates the processing.

On the one hand, when Tc+Tm>Tmax (No in St12), the token management unit 21 terminates the processing with the accumulation amount Tc as the maximum accumulation amount Tmax (St14). Thus, the token management unit 21 performs the processing.

In this manner, the token management unit 21 supplies tokens to the policer #1 at a fixed policing rate common to each group of the policer #i. The tokens are subtracted when a packet passes through any policer #i in the group.

With reference to FIG. 4 again, the policing unit 1 is an example of a passing controller. The policing unit 1 determines based on a token whether or not a packet may pass, and allows the packet to pass or discards the packet based on a result of the determination. More specifically, the policing unit 1 determines whether or not a packet may pass based on a result of a comparison of the accumulation amount Tc of tokens and a predetermined threshold. Then, the policing unit 1 allows the packet to pass or discards the packet according to the result of the comparison. While the threshold is 0 in this example, a threshold is not limited to this.

Thus, the policing unit 1 allows the packet to pass when Tc>0 and discards the packet when Tc≦0. The packet that passes is outputted to the distribution unit 82. The policing unit 1 may also determine whether or not the packet may pass based on a comparison result of packet length (that is to say, a data amount) and the accumulation amount Tc of tokens. In this case, the policing unit 1 allows the packet to pass when Tc≧L and discards the packet when Tc<L. Thus, the accumulation amount Tc of tokens is larger than 0 at all times and does not become a negative value.

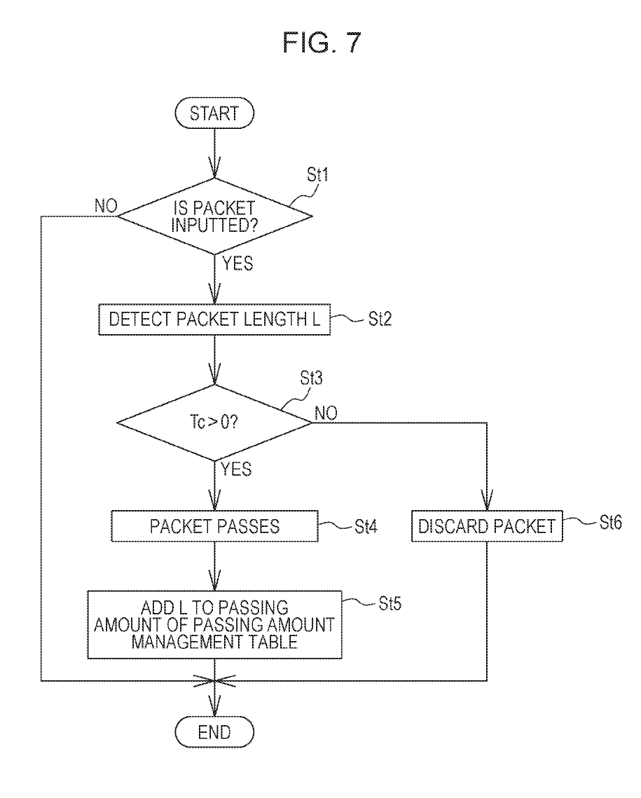

FIG. 7 is a flowchart illustrating an example of processing of the policing unit 1. The processing is repeatedly performed at a fixed cycle.

First, the policing unit 1 detects whether or not a packet is inputted (St1). When the packet is not inputted (No in St1), the policing unit 1 terminates the processing. When the packet is inputted (Yes in St1), the policing unit 1 detects inputted packet length L (St2). Packet length is detected through the use of a byte counter, for example.

Then, the policing unit 1 determines whether or not the accumulation amount Tc of tokens is larger than 0 (St3). When Tc≦0 (No in St3), the policing unit 1 discards the packet (St6) and terminates the processing. When Tc>0 (Yes in St3), the policing unit 1 allows the packet to pass (St4).

Then, the policing unit 1 adds the packet length L to a passing amount of the policer #i registered in the passing amount management table 30 (St5) and terminates the processing. In this manner, the policing unit 1 performs the processing.

The passing amount notifier 31 is an example of a passing amount management unit and manages a data amount (Byte) of a packet that passes through each of the policers #1 to #M, that is to say, a passing amount. A passing amount of each of the policers #1 to #M is registered in the passing amount management table 30. As described above, every time a packet passes through the policer #i, the packet length L is added to a passing amount of the policer #i.

The passing amount notifier 31 measures a passing amount of a packet for a certain period of time, with the passing amount management table 30. In this example, while the passing amount notifier 31 acquires a passing amount of each of the policers #1 to #M at an interval of 10 (ms) from the passing amount management table 30, the passing amount notifier 31 may acquire the passing amount at time interval that varies for each group of the policers #i, depending on settings from the controller 914, as described below.

The passing amount notifier 31 notifies numeric values of the high-order-side digits of a passing amount to the bandwidth controller 81 of the IF card 91 and another IF card 91, and carries over numeric values of a low-order-side of the passing amount to a passing amount to be measured in a following period. More specifically, the passing amount notifier 31 notifies the bandwidth controller 81 of the other IF card 91 of only the numeric values of some of the high-order-side digits rather than numeric values of all digits of the passing amount, and leaves the numeric values of the remaining low-order-side digits to the passing amount management table 30.

With this, the amount of information to be notified is reduced without degrading precision of bandwidth control. As described below, the passing amount notifier 31 acquires from the passing amount management table 30 bit values for 4 bits from the most significant bit (MSB) in a bit string representing a binary number representation of a passing amount and notifies the bit values.

The passing amount receiver 41 receives the numeric values transmitted from the passing amount notifier 31 of the bandwidth controller 81 of the IF card 91 and the other IF card 91. The passing amount receiver 41 is an example of a passing amount acquisition unit. The passing amount receiver 41 obtains a provisional passing amount by returning to the original digit the numeric values notified by the bandwidth controller 81 of the other IF card 91.

A provisional passing amount is a rough passing amount represented by only numeric values of high-order digits of a passing amount measured by the passing amount notifier 31. The passing amount receiver 41 registers a provisional passing amount for every policer in the provisional passing amount management table 40. As described below, when obtaining a provisional passing amount, the passing amount receiver 41 acquires the most significant bit of the bit string indicating the passing amount, from the provisional passing amount management table 40.

The token management unit 21 subtracts the provisional passing amount of the policer #i registered in the provisional passing amount management table 40 from the accumulated amount Tc of tokens of the policer #i. With this, the tokens of the policer #i are subtracted for every period during which the provisional passing amount of packets that pass through the policer #i or another policer #i in the same group is fixed. Therefore, total bandwidth of traffic to be inputted to each policer #i of the plurality of IF cards 91 is limited generally.

The policer table 50 is held in the storage 915 and a policing rate of each policer #1 to #M is registered. As described above, the policing rate is common to a group of policers, more specifically, for every PID, and is registered by the controller 914, for example.

The MSB setting unit 51 calculates the largest value of the passing amount of each policer #1 to #M, based on the policing rate of each policer #1 to #M registered in the policer table 50. The MSB setting unit 51 determines the most significant digit of the passing amount, more specifically, the MSB in the case of a binary number, from the largest value of the passing amount and registers the largest value of the passing amount in the passing amount management table 30 and the provisional passing amount management table 40.

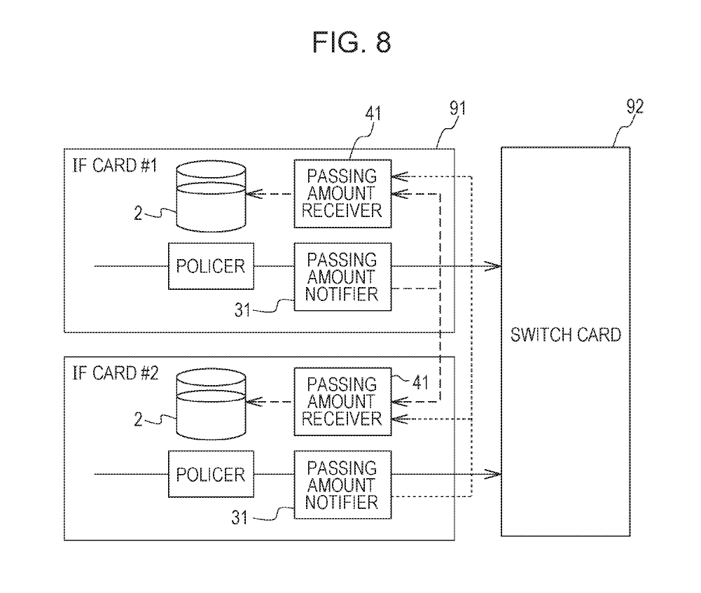

A notification process of a passing amount is described hereinafter. A subsequent description assumes the configuration illustrated in FIG. 8.

FIG. 8 illustrates an example of interface cards that constitute a policing group. Between an IF card (#1) 91 and an IF card (#2) 91, policers #1 to #M having the same PID belong to the same group. Thus, the passing amount notifier 31 of the IF card (#1) 91 transmits a numeric value of a passing amount to each passing amount receiver 41 of the IF card (#1) 91 and the IF card (#2) 91. The passing amount notifier 31 of the IF card (#2) 91 also transmits the numeric value of the passing amount to each passing amount receiver 41 of the IF card (#1) 91 and the IF card (#2) 91.

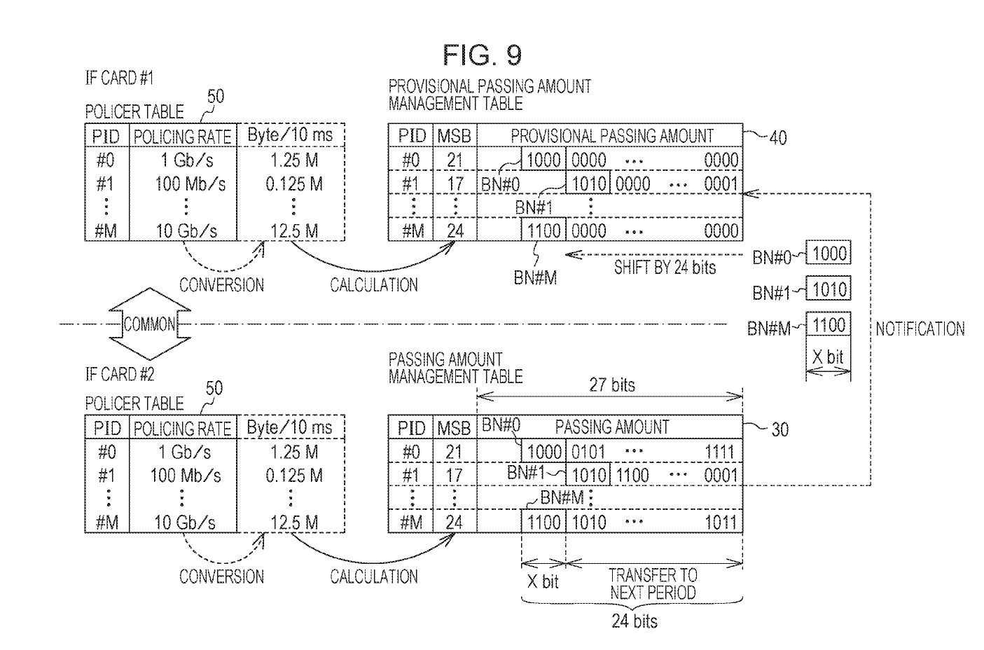

FIG. 9 illustrates an example of a notification process of a passing amount. This example illustrates a case in which numeric values of passing amounts of the policer #1 to #M of the IF card (#2) 91 are notified to the IF card (#1) 91. However, a similar process is also performed when the numeric value of the passing amounts of the policers #1 to #M of the IF card (#1) 91 are also notified to the IF card (#2) 91.

FIG. 9 illustrates the policer table 50 of the IF card (#1) 91 and the IF card (#2) 91, the passing amount management table 30 of the IF card (#1) 91, and the passing amount management table 40 of the IF card (#2) 91.

In the policer table 50, setting content which is common between the IF card (#1) 91 and the IF card (#2) 91 is registered. In this example, a policing rate of PID=#0 is 1 (Gb/s). A policing rate of PID=#1 is 100 (Mb/s). A policing rate of PID=#M is 10 (Gb/s).

As described above, a policing rate is common to each group of policers, more specifically, to each PID. Thus, the IF card (#1) 91 and the IF card (#2) 91 may obtain the largest value (upper limit) of a passing amount of each PID measured in the other IF cards (#2, #1) 91 by converting the policing rate.

In the policer table 50 in FIG. 9, the largest value (Byte/10 ms) of the passing amount when the notification interval is 10 (ms) is stated in a dot-line frame. The largest value of the passing amount when PID=#0 is 1.25 (Mbytes/10 ms). The largest value of the passing amount when PID=#1 is 0.125 (Mbytes/10 ms). The largest value of the passing amount when PID=#M is 12.5 (Mbytes/10 ms). The largest values of the passing amounts are stated in the policer table 50 for convenience of description. However, in practice, the largest values of the passing amounts do not have to be registered in the policer table 50.

The MSB in the passing amount management table 30 and the provisional passing amount management table 40 represents the most significant digit when a passing amount is represented in a bit string of a binary number representation, and calculated from the largest amount of the passing amount. For example, the largest value of the passing amount when PID=#0 is 1.25 (Mbytes/10 ms). Thus, by converting 1.25M from the decimal number representation to the binary number representation, the MSB of the PID=#0 is calculated to be 21 bits. With a method similar to this, the MSB of PID=#1 is calculated to be 17 bits, and the MSB of PID=#M is calculated to be 24 bits. Calculation of the MSB and registration to the passing amount management table 30 and the provisional passing amount management table 40 are performed by the MSB setting unit 51.

In the passing amount management table 30, the MSB and a bit string of a passing amount of each PID are registered. While up to a bit string of 27 (bits) may be registered in the passing amount management table 30, only digits below the MSB are used. For example, a passing amount of PID=#0 is registered in a bit string of 21 bits. A passing amount of PID=#1 is registered in a bit string of 17 bits. A passing amount of PID=#M is registered in a bit string of 24 bits.

The passing amount notifier 31 notifies the bandwidth controller 81 of the IF card (#1) 91 of a bit value for some digits from the MSB of a bit string representing a binary number representation of the passing amount, and carries a remainder of the bit string to a passing amount to be measured in a following period. More specifically, the passing amount notifier 31 extracts bit values BN#0, BN#1, BN#M for 4 bits from the MSB of the bit string and notifies the bit values. The number of bits is not limited to 4 bits.

In this example, since a bit string of a passing amount of PID=#0 is “10000101 . . . 1111”, “1000” for 4 bits are notified as the bit value BN#0 from the digit of 21 bits, which is the MSB. A bit string of a passing amount of PID=#1 is “10101100 . . . 0001”. Thus, “1010” for 4 bits are notified as the bit value BN#1 from the digit of 17 bits, which is the MSB. Furthermore, a bit string of a passing amount of PID=#M is “11001010 . . . 1011”. Thus, “1100” for 4 bits are notified as the bit value BN#M from the digit of 24 bits, which is the MSB.

The passing amount receiver 41 obtains a provisional passing amount by shifting and fitting bit values BN#0, BN#1, BN#M, notified by the passing amount notifier 31, into the MSB. For example, the passing amount receiver 41 obtains a provisional passing amount (bit string “11000000 . . . 0000”) by shifting the bit value BN#M to the high-order-side only by 24 bits. With a method similar to this, the passing amount receiver 41 obtains a provisional passing amount by shifting the bit value BN#0 only by 21 bits and the bit value BN#1 only by 17 bits.

Referring to the MSB in the provisional passing amount management table 40, the passing amount receiver 41 determines the number of bits to be shifted. In the IF card (#1) 91 and the IF card (#2) 91, since the MSB is set based on a policing rate that is common in the same group, the passing amount receiver 41 may normally obtain a provisional passing amount based on a numeric value notified by the passing amount notifier 31.

In this manner, since the passing amount notifier 31 may notify only numeric values of some digits on the high-order-side (4 (bits) in this example) to the bandwidth controller 81 of the other IF card 91, rather than numeric values of all digits of the passing amount, the amount of information to be notified for bandwidth control is reduced.

The passing amount notifier 31 notifies a bit value BN#i for some digits (4 (bits) in this example) from the most significant bit (MSB) of a bit string representing a binary number representation of a passing amount. The passing amount receiver 41 shifts the bit value BN#i for some digits notified to fit the bit value BN#i into the most significant bit.

Thus, according to this example, a passing amount may be notified with less amount of information than when some digits of a decimal number representation or a hexadecimal number representation of a passing amount are notified by a bit string. A passing amount may be notified by a bit string of a decimal number representation or a hexadecimal number representation, instead of a binary number representation, though.

Furthermore, the passing amount notifier 31 notifies the numeric value BN#i (4 (bits) in this example) for a predetermined number of digits from the most significant digit (MSB) of a passing amount calculated from the largest value of a passing amount based on a policing rate. The passing amount receiver 41 obtains a provisional passing amount by carrying the digit of the notified numeric value BN#i to fit into the most significant digit (MSB).

The passing amount notifier 31 and the passing amount receiver 41 may calculate the most significant digit based on the common policing rate. Thus, the passing amount receiver 41 may normally obtain the provisional passing amount. Therefore, since the passing amount notifier 31 does not have to notify the passing amount receiver 41 of the most significant digit, the amount of information to be notified is reduced.

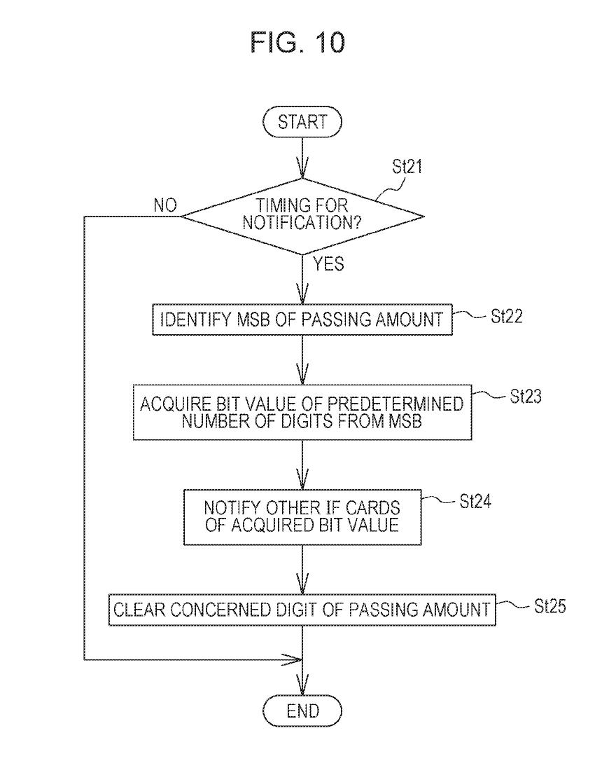

FIG. 10 is a flowchart illustrating an example of processing of the passing amount notifier 31. The processing is repeatedly performed at a fixed cycle.

First of all, the passing amount notifier 31 determines whether or not timing for notification comes (St 21). The passing amount notifier 31 detects the timing for notification by an internal timer, for example.

While the timing for notification comes every 10 (ms), for example, the timing for notification may vary depending on a group, as described below.

When the timing for notification does not come (No in St21), the passing amount notifier 31 terminates the processing. When the timing for notification comes (Yes in St21), the passing amount notifier 31 identifies the MSB of the passing amount (St22). In this example, the passing amount notifier 31 identifies the MSB from the passing amount management table 30. However, as described below, the most significant digit representing “1” may be identified as the MSB from bit strings representing a binary number representation of the passing amount.

Then, the passing amount notifier 31 acquires the bit value BN#i for a predetermined number of digits from the MSB in the bit strings of the binary number representation of the passing amount (St23). In this example, the passing amount notifier 31 extracts the bit value BN#i for 4 bits from the MSB from the bit string of the binary number representation of the passing amount.

Then, the passing amount notifier 31 notifies the bandwidth controller 81 of the other IF card 91 of the acquired bit value BN#i (St24). Then, the passing amount notifier 31 clears to 0 the digit of the notified bit value BN#i of the bit string of the passing amount to the passing amount management table 30 (St 25). Thus, the remaining bit value is carried to a passing amount to be measured in a following period, without being cleared. In this manner, the passing amount notifier 31 performs processing.

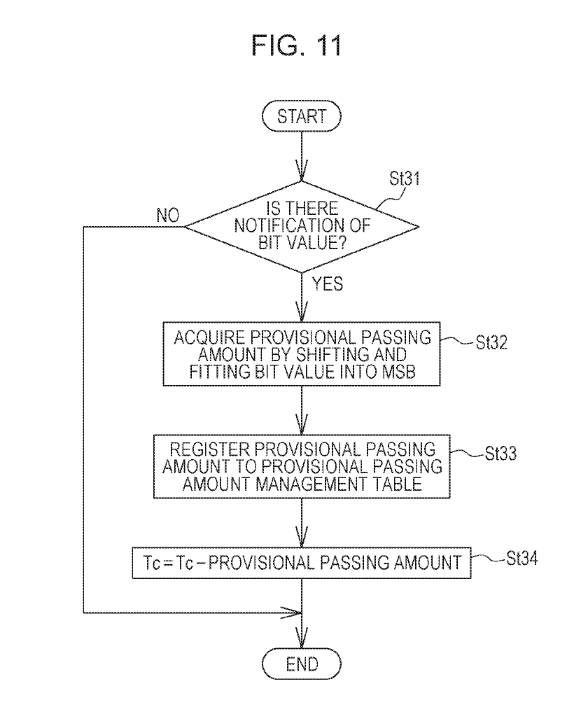

FIG. 11 is a flowchart illustrating an example of processing of the passing amount receiver 41. The processing is repeatedly performed at a fixed cycle.

First, the passing amount receiver 41 determines whether or not there is a notice of the bit value BN#i from the passing amount notifier 31 of the other card 91 (St31). If there is no notice (No in St31), the passing amount receiver 41 terminates processing.

Then, the passing amount receiver 41 acquires a provisional passing amount by shifting to the high-order-side and fitting the bit value BN#i into MSB (St32). Then, the passing amount receiver 41 registers the provisional passing amount in the provisional passing amount management table 40 (St33).

Then, the passing amount receiver 41 requests the token management unit 21 to subtract the provisional passing amount from the accumulated amount Tc of tokens (more specifically, so that Tc=Tc−provisional passing amount) (St34). In this manner, the passing amount receiver 41 performs processing.

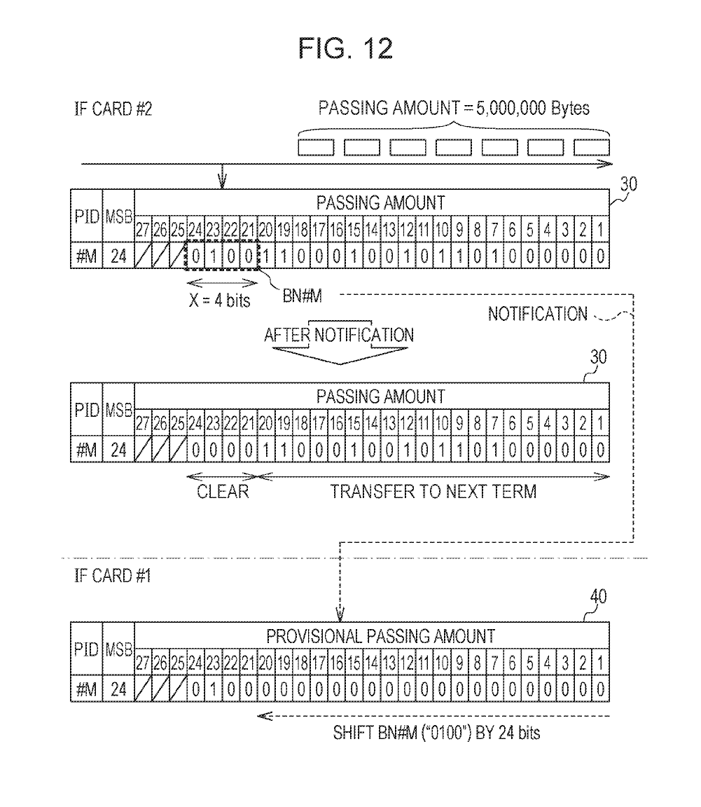

FIG. 12 illustrates an example of processing of the passing amount management table 30 and the provisional passing amount management table 40. In this example, it is assumed that passing amounts of packets of the policer #M of the IF card (#2) 91 within a certain period of time are 5,000,000 (Bytes).

Thus, a bit string “010011000100101101000000” representing a binary number representation of 5,000,000 (Bytes) is recorded as a passing amount of the policer #M in the passing amount management table 30 of the IF card (#2) 91. The passing amount notifier 31 extracts the bit value BN#M for a predetermined number of digits (X) from the MSB (=24) of the bit string and notifies the bandwidth controller 81 of the IF card (#1) 91 of the bit value BN#M. In this example, the bit value BN#M (=“0100”) for X=4 (bits) is notified.

In the IF card (#1) 91, the passing amount receiver 41 shifts the bit value BN#M notified by the passing amount notifier 31 of the IF card (#1) 91 to fit the bit value BN#M into the MSB (=24). More specifically, the passing amount receiver 41 shifts the bit value BN#M to the high-order-side only by 24 bits. More specifically, the passing amount receiver 41 returns the bit BN#M which is a numeric value of the high-order-side digit, to the digit of the original MSB. As described above, the MSB is calculated by the MSB setting unit 51 from the largest value of the passing amount based on the policing rate and set in the passing amount management table 30 and the provisional passing amount management table 40.

In this manner, the passing amount receiver 41 obtains a provisional passing amount and records the provisional passing amount in the provisional passing amount management table 40. Since a provisional passing amount is a numeric value with bit values of all digits being “0” other than the bit value BN#i on the MSB side which is the numeric value of the high-order-side digit of the passing amount in the bit string of the passing amount, the provisional passing amount has an error from the passing amount.

However, since numeric values of the low-order-side of the passing amount are carried to a passing amount to be measured in a following period, the numeric values of the low-order-side of the passing amount are reflected in a numeric value notified to the bandwidth controller 81 of the IF card (#1) 91 in the following period. More specifically, after notifying the bit value BN#M, the passing amount notifier 31 of the IF card (#1) 91 clears to 0 bit values of 21 to 24 bits which are digits of the bit value BN#M in the bit string of the passing amount and keeps bit values of other digits not cleared.

Thus, a bit value “11000100101101000000” of the remaining low-order-side (1 to 20 bits) in the bit string of the passing amount is added to a passing amount to be measured in a following period. More specifically, in the following period, counting of the passing amount is started from not 0 (Byte) but 805696 (Bytes) (decimal number representation of “11000100101101000000”). Thus, precision of bandwidth control in this example is maintained to the same degree as a case in which a passing amount itself is notified. This is described hereinafter with a simulation result.

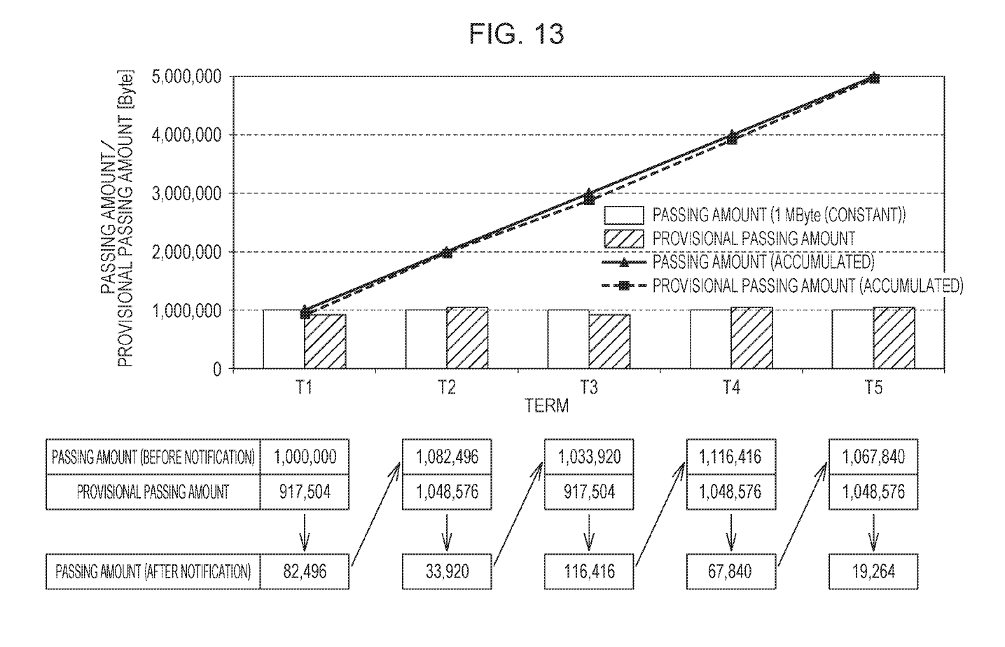

FIG. 13 is a graph illustrating an example of a change in a passing amount and a provisional passing amount in each term. In FIG. 13, an actual passing amount and a provisional passing amount in each period T1 to T5 are illustrated by using a bar graph. Then, a cumulative value of the passing amount and a cumulative value of the provisional passing amount are illustrated by using a line graph. An actual passing amount indicates a data amount of packets that actually pass, to which no numeric values of the low-order-side of the passing amount in the previous period T1 to T5 are added. In this example, it is assumed that the actual passing amount is a fixed value (1 (Mbyte)).

In the lower part of the graph, a passing amount (before notification), a provisional passing amount, and a passing amount after notification in each period T1 to T5 are stated in decimal numbers. Here, the passing amount after notification indicates a passing amount after a bit value for 4 bits on the side of the MSB to be notified (more specifically, X=4 (bits)) in the bit stream of the passing amount is cleared to 0.

In the first period T1, 917504 (Bytes), which is less than the actual passing amount of 1000000 (Bytes), is notified and processed as a provisional passing amount.

A passing amount in the following period T2 is 1082496 (Bytes) as the passing amount of 82496 (Bytes) after notification of the previous period T1 is added to the actual passing amount of 1000000 (Bytes). In the period T2, 1048576 (Bytes) which is more than the actual passing amount of 1000000 (Byes) is notified and processed as a provisional passing amount.

A passing amount in the following period T3 is 1033920 (Bytes) as the passing amount of 33920 (Bytes) after notification of the previous period T2 is added to the actual passing amount of 1000000 (Bytes). In the period T3, 917504 (Bytes) which is less than the actual passing amount of 1000000 (Bytes) is notified and processed as a provisional passing amount.

A passing amount in the following period T4 is 1116416 (Bytes) as the passing amount of 116416 (Bytes) after notification of the previous period T3 is added to the actual passing amount of 1000000 (Bytes). In the period T4, 1048576 (Bytes) which is more than the actual passing amount of 1000000 (Byes) is notified and processed as a previous passing amount.

A passing amount in the following period T5 is 1067840 (Bytes) as the passing amount of 67840 (Bytes) after notification of the previous period T4 is added to the actual passing amount of 1000000 (Bytes). In the period T5, 1048576 (Bytes) which is more than the actual passing amount of 1000000 (Byes) is notified and processed as a previous passing amount.

As such, a provisional passing amount may be more than or less than an actual passing amount for each in terms T1 to T5. Thus, while a difference is present between the passing amount and the provisional passing amount of each of the periods T1 to T5, there is little difference in the cumulative value of the passing amount and the cumulative amount of the provisional passing amount. Therefore, the precision of bandwidth controller in this example is maintained to the same degree as the case in which the passing amount itself is notified.

In this example, while the passing amount notifier 31 notifies a numeric value for a predetermined number of digits from the most significant digit of the passing amount calculated from the largest value of the passing amount based on the policing rate, the numeric value is not limited to this. The passing amount notifier 31 may also notify the most significant digit of the passing amount and a numeric value for the predetermined number of digits from the most significant digit of the passing amount. In this case, the passing amount receiver 41 obtains a provisional passing amount by carrying the digit of the notified numeric value for the predetermined number of digits to fit into the notified most significant digit. An example in this case is described below.

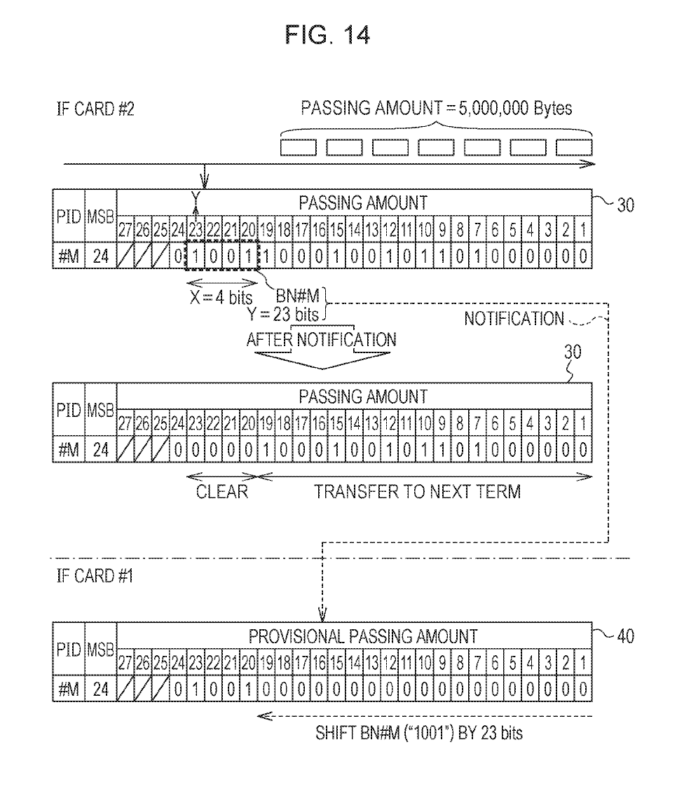

FIG. 14 illustrates another example of processing of the passing amount management table 30 and the provisional passing amount management table 40. In this example, it is assumed that passing amount of packets of the policer #M of the IF card (#2) 91 during a certain period of time is 5000000 (Bytes).

Thus, a bit string “010011000100101101000000” representing a binary number representation of 5,000,000 (Bytes) is recorded as a passing amount of the policer #M in the passing amount management table 30 of the IF card (#2) 91. The passing amount notifier 31 extracts the bit value BN#M for a predetermined number of digits (X) from the most significant digit (Y) for which the bit value is “1” in the bit string and notifies the bandwidth controller 81 of the IF card (#1) 91 of the bit value BN#M.

In this example, the most significant digit for which the bit value is “1” is 23 (Y=23), and the number of digits X to be notified is 4 (bits). Thus, the passing amount notifier 31 notifies the bit value BN#M (=“1001”) of the digits of 20 to 23 bits, in the bit string of the passing amount. The passing amount notifier 31 notifies the most significant digit Y=23 (bits) together with the bit value BN#M.

After notifying the bit value BN#M, the passing amount notifier 31 clears to 0 a bit value of 20 to 23 bits which are the digits of the bit value BN#M in the bit stream of the passing amount, and keeps bit values of other digits not cleared. Thus, a bit value “1000100101101000000” of the remaining low-order-side digits (1 to 19 bits) in the bit string of the passing amount is added to a passing amount to be measured in a following period.

More specifically, this bit value is carried to a passing amount measured in a following period. Therefore, similar to the above example, the precision of bandwidth control in this example is maintained to the same degree as the case in which the passing amount itself is notified.

In the IF card (#1) 91, the passing amount receiver 41 shifts the bit value BN#M notified by the passing amount notifier 31 of the IF card (#2) 91 to fit the bit value BN#M into the most significant digit Y=23 bits notified similar to this. More specifically, the passing amount receiver 41 shifts the bit value BN#M to the high-order-side only by 23 bits. In this manner, the passing amount receiver 41 obtains a provisional passing amount and records the provisional passing amount in the provisional passing amount management table 40.

As such, in this example, the passing amount notifier 31 omits notification of a bit value “0” of a digit of 24 bits in a bit string of a passing amount, and instead notifies the bit value BN#M of a digit of 20 bits. More specifically, rather than wastefully being notified of the bit value “0” of the high-order-side digit in the bit string, the passing amount notifier 31 notifies a bit value of the low-order-side digit. This improves the precision of a provisional passing amount.

For example, when this example is compared with the previous example illustrated in FIG. 12, while the provisional passing amount in this example is 4718592 (Bytes) in a decimal number representation, the provisional passing amount in the previous example is 4194304 (Bytes) in a decimal number representation. Thus, the provisional passing amount in this example is closer to the passing amount of 5,000,000 (Bytes) than the provisional passing amount in the previous example.

In the examples described so far, the number of digits (X (bit)) of the bit value BN#M to be notified and time interval of notification, more specifically, a period of measurement of a passing amount may vary depending on a group of policers.

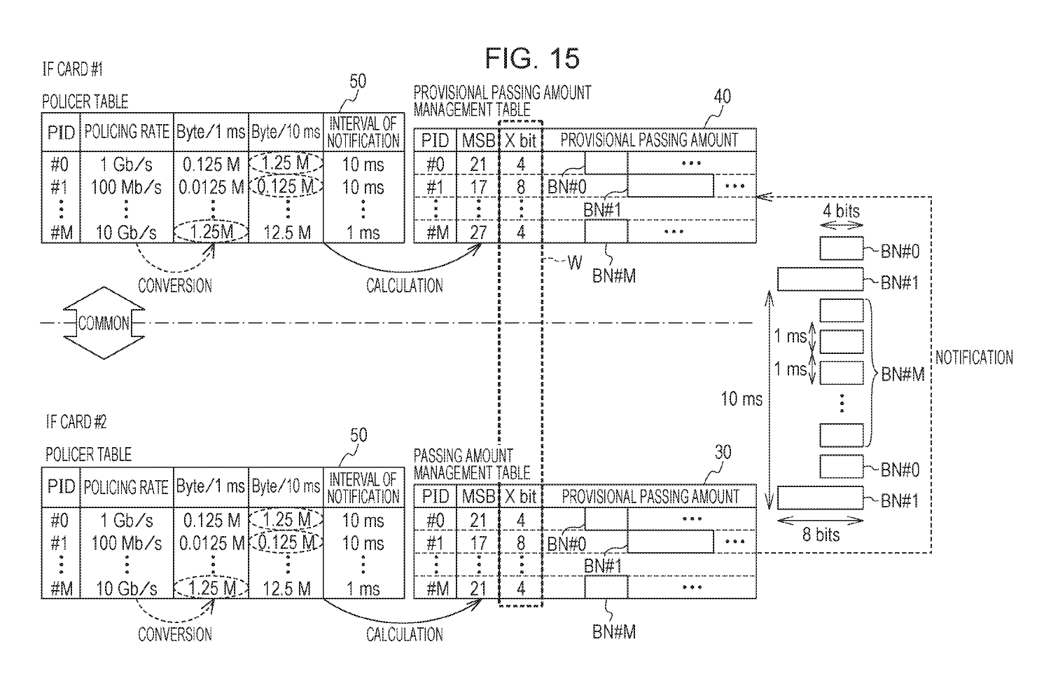

FIG. 15 illustrates another example of a notification process of a passing amount. In this example, the number of digits (X (bits)) of the bit value BN#M to be notified and time interval of notification (hereinafter referred to as a “notification interval”) may vary depending on a group of a policer #0, #1, #M.

Thus, a common notification interval for each group is set for each policer table 50 of the IF card (#1) 91 and the IF card (#2) 91. The passing amount notifier 31 of the IF card (#2) 91 performs a notification process at the notification interval for each of the policers #1 to #M set in the policer group 50. Setting of a notification interval is performed by a controller 914, for example.

In this example, a notification interval of the policers #0, #1 is 10 (ms) similar to the above example, and a notification interval of the policer #M is 1 (ms). A policing rate of the policer #M is 10 (Gb/s), and when converted to a data transmission amount per 1 ms, this is 1.25 (Bytes/ms). Thus, 21 bits are set as the MSB of the PID #M in the passing amount management table 30 of the IF card (#2) 91.

In this manner, by making a notification interval of the group of policers #M whose policing rate is highest shorter than other groups of policers #0, #1, precision of policing of the policer #M may be improved.

The number of digits X (bit) common to each of the policers #1 to #M is set in the passing amount management table 30 of the IF card (#2) 91 and the provisional passing amount management table 40 of the IF card (#1) 91 (see the symbol W). The passing amount notifier 31 of the IF card (#2) 91 notifies the bit values #BN#0, #1, #M for X (bit) set in the passing amount management table 30.

On the one hand, the passing amount receiver 41 of the IF card (#1) 91 receives the bit values BN#0, #1, #M of the X (bit) set in the provisional passing amount management table 40. With this, the bit values BN#0, #1, #M of the X (bit) are normally transmitted or received between the IF card (#1) 91 and the IF card (#2) 91. X (bit) is set by the controller 914, for example.

In this example, X (bit) of the policers #0, #M is 4 (bits), and X (bit) of the policer #1 is 8 (bits). Thus, the precision of policing of the policer #1 is higher than the policer #0 having the same notification interval. Unlike this example, the precision of policing of the policer #M may be improved, by setting a notification interval of the group of the policer #M having the highest policing rate to the same value (10 ms) as other groups of policers #0, #1, and setting X (bit) of the policer #M to a value larger than other policers #0, #1.

In this manner, in this example, the number of digits (X (bit)) of numeric values of the high-order-side digit to be notified to the other IF card 91 or a notification interval, more specifically, a measurement period of a passing amount, varies depending on a group of the policers #0, #1, #M. Therefore, the precision of policing may be adjusted for each group of the policers #0, #1, #M.

The effect of the example described above is described hereinafter. In the following description, a case in which group policing is performed between the policers #M of the IF card (#1) 91 and the IF card (#2) 91.

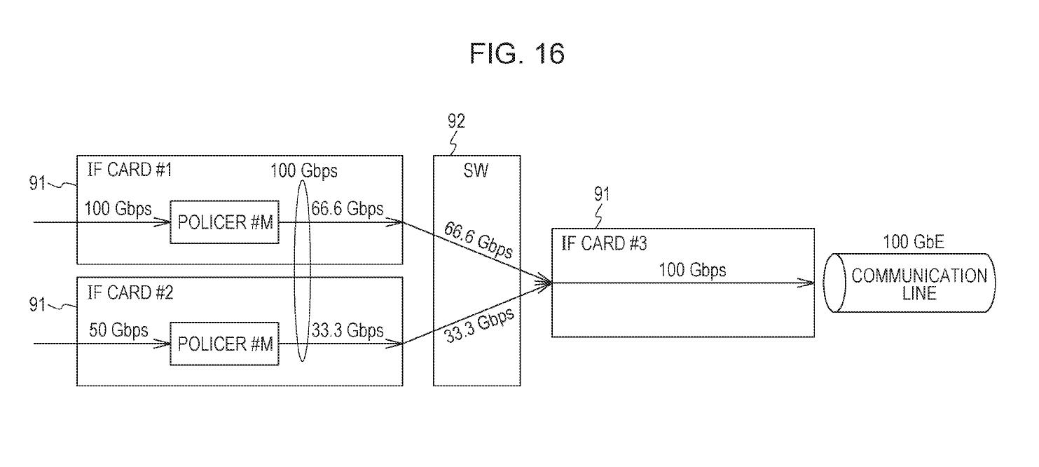

FIG. 16 illustrates an example of bandwidth control. Each policer #M of the IF card (#1) 91 and the IF card (#2) 91 limits a passband of packets with a policing rate of a total of 100 (Gbps). Here, an input rate of packets of the policers #M of the IF card (#1) 91 and the IF card (#2) 91 is 100 (Gbps) and 50 (Gbps), respectively.

Packets outputted from each policer #M of the IF card (#1) 91 and the IF card (#2) 91 are inputted to an IF card (#3) 91 on the output side by way of the switch card (SW) 92. The IF card (#3) 91 transmits a packet to another device by way of a communication line of 100 gigabit Ethernet (GbE).

An output rate of packets of each policer #M of the IF card (#1) 91 and the IF card (#2) 91 is determined so that a passage rate may be uniform, by way of example. Thus, an expected value of the output rate of the packet of each policer #M is a value to which a policing rate is assigned depending on a ratio of the input rates.

Sr=Pr×(Nr/ΣNr) (1)

More specifically, when the input rate is Nr and the policing rate is Pr, the expected value Sr of the output rate is calculated by the expression (1) above. Here, ΣNr is a total of the input rates of respective policers M.

Therefore, the expected value of the output rate of the packet of the policer #M of the IF card (#1) 91 is 100×100/(100+50)=66.6 (Gbps). Then, the expected value of the output rate of the packet of the policer #m of the IF card (#2) 91 is 100×50/(100+50)=33.3 (Gbps). Then, the passage rate of each policer #M is equally 66.6(%). With this, packets are inputted to the IF card (#3) 91 on the output side at the input rate of a total of approximately 100 (Gbps).

Bandwidth control is not limited to the scheme of making fair the passage rate between the policers #M in the same group as described above, and a scheme of making a passing amount of packets fair is also used. In this case, each policer #M of the IF card (#1) 91 and the IF card (#2) 91 equally outputs packets to the switch card 92 at an output rate of 50 (Gbps) as an expected value. With this, packets are inputted to the IF card (#3) 91 on the output side at an input rate of a total of 100 (Gbps).

A simulation result of the output rates of each policer #M of the IF card (#1) 91 and the IF card (#2) 91 in the bandwidth control illustrated in FIG. 16 is described hereinafter.

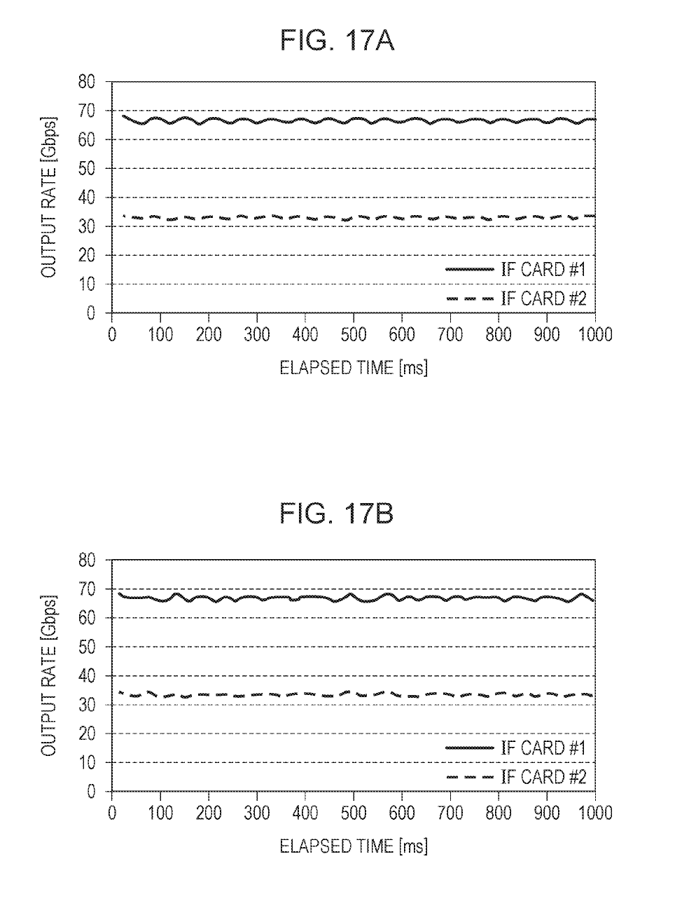

FIG. 17A is a graph illustrating a simulation result of an output rate in a comparative example. In FIG. 17A, the horizontal axis represents elapsed time (ms) and the vertical axis represents an output rate (Gbps). In the comparative example, the passing amount notifier 31 of the IF card (#1) 91 notifies the passing amount receiver 41 of the IF card (#2) 91 of all bit strings of 27 bits representing a binary number representation of a passing amount.

As illustrated in FIG. 17A, an output rate of the policer #M of the IF card (#1) 91 is approximately 66.6 (Gbps). An output rate of the policer #M of the IF card (#2) 91 is approximately 33.3 (Gbps). Thus, it may be stated that the output rates of respective policers #M of the IF card (#1) 91 and the IF card (#2) 91 are as per an expected value.

On the other hand, FIG. 17B is a graph illustrating a simulation result of the output rate in the example described above. In FIG. 17B, the horizontal axis represents elapsed time (ms) and the vertical axis represents the output rate (Gbps). In this example, the passing amount notifier 31 of the IF card (#1) 91 notifies the passing amount receiver 41 of the IF card (#2) 91 of the bit value BN#M of X=4 (bits) on the side of the MSB in the bit string representing a binary number representation of the passing amount.

As illustrated in FIG. 17B, the output rate of the policer #M of the IF card (#1) 91 is maintained at approximately 66.6 (Gbps) although a degree of fluctuations is larger than the comparative example. The output rate of the policer #M of the IF card (#2) 91 is also approximately 33.3 (Gbps) although a degree of fluctuations is larger than the comparative example. Thus, it may be stated that the output rates of respective policers #M of the IF card (#1) 91 and the IF card (#2) 91 are as per an expected value, similar to the comparative example.

In this manner, according to the example, not only an amount of information of a passing amount to be notified from the IF card (#1) 91 to the IF card (#2) 91 is reduced to about one-seventh (=4 (bits)/27 (bits)), but also the precision of bandwidth control (policing) is maintained to the same degree as the comparative example in which the passing amount itself is notified.

The token packet scheme as described above is to place a limitation on a mean of a packet transfer rate while allowing some degree of burst for an input rate of packets. Thus, the precision desired for policing obtained from a long-term perspective (macroscopic perspective) is more important than the precision desired for policing obtained from a short-term perspective (microscopic perspective). Therefore, the advantage of reducing an amount of information to be notified while maintaining the precision of the macroscopic perspective (see FIG. 13) even if the precision of the microscopic perspective degrades is desirable for group policing.

As described so far, the packet relay device according to the examples has the plurality of bandwidth controllers 81 configured to control each of bandwidth of a passing packet. Each of the bandwidth controllers 81 includes the policing unit 1, the passing amount notifier 31, the passing amount receiver 41, and the token management unit 21.

Based on tokens that are supplied at a fixed policing rate and subtracted due to passage of a packet, the policing unit 1 determines whether or not a packet may pass. Then, according to the determination result, the policing unit 1 allows the packet to pass or discards the packet. The passing amount notifier 31 measures a passing amount of a packet for every certain period of time. Then, the passing amount notifier 31 notifies another bandwidth controller 81 of numeric values of the high-order-side digit of the passing amount and carries numeric values of the low-order-side digit of the passing amount to a passing amount to be measured in a following period.

The passing amount receiver 41 obtains a provisional passing amount by returning the numeric value of the high-order-side digit notified by the other bandwidth controller 81 to the digit. The token management unit 21 subtracts he provisional passing amount from the token.

With the above configuration, the passing amount notifier 31 notifies the other bandwidth controller 81 of only numeric values of some high-order-side digits rather than a numeric value of all digits of the passing amount. Thus, an amount of information to be notified for bandwidth control is reduced.

The passing amount notifier 31 carries the numeric value of the low-order-side digit of the passing amount to a passing amount to be measured in a following period. Thus, the numeric value of the low-order-side of the passing amount is reflected in a numeric value to be notified to the other bandwidth controller 81 in the following period. Therefore, the precision of bandwidth control is maintained to the same degree as the case in which the passing amount itself is notified.

Thus, the packet relay device according to this example enables bandwidth control by which the amount of information to be notified is reduced.

The bandwidth control method according to this example is a method wherein each of the plurality of bandwidth controllers 81 performs the following steps in a method of controlling bandwidth of each packet passing through the plurality of bandwidth controllers 81.

Step (1): Determining whether or not a packet may pass based on tokens that are supplied at a fixed policing rate and subtracted due to passage of a packet, and allowing the packet to pass based on the determination result or discarding the packet.

Step (2): Measuring a passing amount of packets for a certain period of time.

Step (3): Notifying the other bandwidth controller 81 of a numeric value of the high-order-side digit of the passing amount.

Step (4): Carrying a numeric value of the low-order-side of the passing amount to a passing amount to be measured in a following period.

Step (5): Obtaining a provisional passing amount by returning the numeric value of the high-order-side digit notified by the other bandwidth controller to the digit.

Step (6): Subtracting a provisional passing amount from the tokens.

Since the bandwidth control method according to the examples includes a similar configuration to the packet relay device described above, the bandwidth control method has the operation and effect similar to what has been described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A bandwidth control method executed by one of a plurality of interface devices included in a packet relay device and that process transmission or reception of a packet, the bandwidth control method comprising:
measuring a passing amount of a packet, the passing amount being represented by a numeric value of a plurality of digits;
notifying another interface device among the plurality of interface devices of a numeric value of a high-order-side digit of the plurality of digits;
adding a numeric value of a low-order-side digit of the plurality of digits of the passing amount to a passing amount of a packet to be measured in a following period according to a predetermined measurement interval;
calculating a provisional passing amount by adding the numeric value of the high-order-side digit notified by the another interface device to the measured passing amount;
determining whether to allow a target packet to pass when the target packet is received, based on a result of subtracting the provisional passing amount from an allowable passing amount that increases at a predetermined rate and decreases when a packet passes;
allowing the target packet to pass when determining that the target packet is allowed to pass; and
discarding the target packet when determining that the target packet is not allowed to pass.

2. The bandwidth control method according to claim 1,
wherein the measuring includes measuring the passing amount by adding packet length of a passing packet to the passing amount every time a packet passes.

3. The bandwidth control method according to claim 1, wherein
the notifying includes notifying the other interface device of a numeric value for a predetermined number of digits from a most significant digit of the passing amount calculated from a largest value of the passing amount, and
the calculating includes calculating the provisional passing amount by fitting the digit of the numeric value for the predetermined number of digits notified by the other interface device into the most significant digit of the passing amount.

4. The bandwidth control method according to claim 3, further comprising
calculating the largest value of the passing amount based on the predetermined rate of each of the plurality of interface devices.

5. The bandwidth control method according to claim 1, wherein
the notifying includes notifying the other interface device of the most significant digit of the passing amount and a numeric value for a predetermined number of digits from the most significant digit of the passing amount, and
the calculating includes calculating the provisional passing amount by fitting the numeric value for the predetermined number of digits notified by the other interface device into the most significant digit notified by the other interface device.

6. The bandwidth control method according to claim 1, wherein
the notifying includes notifying a bit value for some digits from a most significant bit of a bit string representing a binary number representation of the passing amount,
the adding includes adding a remaining value of the bit string to a passing amount of a packet to be measured in a following period, and
the calculating includes calculating the provisional passing amount by shifting the bit value for some digits notified by the other interface device to fit the bit value into the most significant bit.

7. The bandwidth control method according to claim 1,
wherein each of the plurality of interface devices belongs to any of a plurality of groups for which a combination of the predetermined rate and the number of digits of the numeric value of the high-order-side digit varies.

8. The bandwidth control method according to claim 1,
wherein each of the plurality of interface devices belongs to any of a plurality of groups for which a combination of the predetermined rate and the measurement interval varies.

9. A packet relay device, comprising
a plurality of interface devices that process transmission or reception of a packet,
wherein each of the plurality of interface devices is configured to:
measure a passing amount of the packet, the passing amount being represented by a numeric value of a plurality of digits,
notify another interface device among the plurality of interface devices of a numeric value of a high-order-side digit of the plurality of digits,
add a numeric value of a low-order-side digit of the plurality of digits of the passing amount to a passing amount of a packet to be measured in a following period according to a predetermined measurement interval,
calculate a provisional passing amount by adding the numeric value of the high-order-side digit notified by the another interface device to the measured passing amount,
determine whether to allow a target packet to pass when the target packet is received, based on a result of subtracting the provisional passing amount from an allowable passing amount that increases at a predetermined rate and decreases when the packet passes,
allow the target packet to pass when determining that the target packet is allowed to pass, and
discard the target packet when determining that the target packet is not allowed to pass.

10. A non-transitory computer-readable storage medium storing a program that causes a packet relay device to execute a process, the packet relay device including a plurality of interface devices, the process comprising:
measuring a passing amount of a packet, the passing amount being represented by a numeric value of a plurality of digits;
notifying another interface device among the plurality of interface devices of a numeric value of a high-order-side digit of the plurality of digits;
adding a numeric value of a low-order-side digit of the plurality of digits of the passing amount to a passing amount of a packet to be measured in a following period according to a predetermined measurement interval;
calculating a provisional passing amount by adding the numeric value of the high-order-side digit notified by the another interface device to the measured passing amount;
determining whether to allow a target packet to pass when the target packet is received, based on a result of subtracting the provisional passing amount from an allowable passing amount that increases at a predetermined rate and decreases when the packet passes;
allowing the target packet to pass when determining that the target packet is allowed to pass; and
discarding the target packet when determining that the target packet is not allowed to pass.
